(19) United States
(12) Patent Application Publication
(10) Pub. No.: US 2012/0232984 A1
(43) Pub. Date: Sep. 13, 2012

(54) BRANDED REDEMPTION PORTAL

(75) Inventor: Colin Michael Mooney, Malvern, PA (US)

(73) Assignee: Bank of America Corporation, Charlotte, NC (US)

(21) Appl. No.: 13/163,371

(22) Filed: Jun. 17, 2011

Related U.S. Application Data
(60) Provisional application No. 61/451,991, filed on Mar. 11, 2011.

(51) Int. Cl. G06Q 30/00

(52) U.S. Cl. 705/14.39

(57) ABSTRACT

In general terms, embodiments of the present invention relate to methods and apparatuses for creating, storing, and/or presenting branded redemption portals. For example, in some embodiments, a method is provided that includes: (a) receiving, from a holder of a rewards account, a request for redemption information, where the rewards account is maintained by a financial institution; (b) determining that the rewards account is associated with an organization, where the organization is not the financial institution, and where the organization is associated with a brand; and (c) presenting a redemption portal to the holder, where the redemption portal presents one or more products, and where the redemption portal has a theme that conveys the brand (and/or each of the one or more presented products conveys the brand).

### CROSS-REFERENCE TO RELATED APPLICATIONS

The present application claims priority to U.S. Provisional Patent Application No. 61/451,991, which was filed on Mar. 11, 2011, is entitled “Branded Redemption Portal,” and is incorporated by reference herein in its entirety.

### BACKGROUND

Many financial institutions provide their customers with rewards checking accounts, rewards credit card accounts, and other types of rewards accounts that can accumulate points, miles, and/or other types of rewards. Typically, after being accumulated, these rewards may be redeemed for one or more goods and/or services, such as, for example, gift cards, t-shirts, tickets, statement credits, and/or the like. Because rewards accounts are becoming increasingly popular with customers, there is a need to improve the ways in which financial institutions provide and service these types of accounts.

### SUMMARY OF SELECTED EMBODIMENTS OF THE PRESENT INVENTION

The following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

In general terms, embodiments of the present invention relate to methods and apparatuses for creating, storing, and/or presenting branded redemption portals. For example, in some embodiments, a financial institution may provide a rewards account that can accumulate one or more rewards (e.g., points, miles, rewards dollars, credits, etc.). In such embodiments, the rewards account may also be associated with an organization that is not the financial institution. For example, the rewards account may be maintained by Bank of America® and may be associated with Bass Pro Shops® (e.g., a rewards partner of Bank of America®). In some embodiments, the organization is selected by a holder of the rewards account (e.g., when opening the rewards account, etc.), but in other embodiments, the organization is selected by the financial institution.

Sometime after the rewards account accumulates one or more rewards, the holder may submit a request for redemption information. For example, in some embodiments, the holder may indicate his intention to redeem his rewards for one or more products (e.g., t-shirts, mugs, gift cards, tickets, etc.). In response to this request, some embodiments of the present invention present a redemption portal to the holder, where the redemption portal presents information associated with one or more products, and where the redemption portal has a theme that conveys a brand associated with the organization. The brand may include the name, sign, symbol, trademark, slogan, and/or color combination associated with the organization. In addition to, or instead of, the portal conveying the brand, the one or more products presented to the holder via the portal may convey the brand.

As a specific example, in some embodiments, a rewards account is maintained by Bank of America®, and the holder of the rewards account selects Bass Pro Shops® for association with the rewards account. In such embodiments, the presented redemption portal will have a Bass Pro Shops® theme. For example, a window of the redemption portal may bear the name “Bass Pro Shops®.” As another example, the background and/or wallpaper of the redemption portal may include a fish design that is set against a circular yellow background having a black border (i.e., portal may have the distinctive design and logo associated with Bass Pro Shops®). In addition to, or instead of, the redemption portal itself conveying the Bass Pro Shops® brand, the one or more products presented via the portal may convey the Bass Pro Shops® brand. For example, in some embodiments, the redemption portal presents images, descriptions, and/or other information associated with Bass Pro Shops®-branded merchandise, including, for example, Bass Pro Shops® gift cards, t-shirts, mugs, fishing poles, hats, and/or the like.

In more general terms, some embodiments of the present invention provide a method that includes: (a) receiving, from a holder of a rewards account, a request for redemption information, where the rewards account is maintained by a financial institution; (b) determining that the rewards account is associated with an organization (sometimes referred to herein as the “organization determination” for simplicity), where the organization is not the financial institution, and where the organization is associated with a brand; and (c) presenting a redemption portal to the holder, where the redemption portal presents one or more products, and where the redemption portal has a theme that conveys the brand (and/or each of the presented products conveys the brand).

It will be understood that some embodiments of the present invention are directed to creating and storing one or more branded redemption portals before the holder opens the rewards account, before the organization is associated with the rewards account, before the holder requests the redemption information, and/or before the organization determination is made. In such embodiments, the redemption portals are sometimes referred to herein as “pre-customized redemption portals.” For example, the financial institution that maintains the rewards account may store a plurality of pre-customized redemption portals in a datastore, where each stored portal has a theme that conveys the brand of a predetermined organization (e.g., a Bass Pro Shops® redemption portal, a Make-A-Wish® redemption portal, a Penn State® redemption portal, etc.).

Other embodiments of the present invention are directed to creating one or more branded redemption portals after the holder opens the rewards account, after the organization is associated with the rewards account, after the holder requests the redemption information, and/or after the organization determination is made. In such embodiments, these redemption portals are sometimes referred to herein as “personalized redemption portals.” For example, in some embodiments, an account apparatus is configured to create a personalized redemption portal for a holder of a rewards account based at least partially on the apparatus determining that the rewards account is held by the holder and/or associated with the organization. In some of these embodiments, the account apparatus creates the personalized redemption portal after receiving the holder's request for redemption information but before presenting the portal to the holder. In some embodiments, the apparatus may create the personalized redemption portal within a few minutes and/or seconds of receiving the request for redemption information and/or making the organization determination.

Further, it will be understood that the organization determination can be made in one or more ways. In some embodiments, the organization determination is based at least partially on a determination (e.g., by an apparatus, by a human, etc.) that one or more account materials (e.g., debit/credit card, statement, checkbook, etc.) associated with the rewards account convey an organization's brand. For example, in some embodiments, an account apparatus determines that a rewards account is associated with Penn State® University based at least partially on the apparatus determining that a debit or credit card associated with the rewards account and/or issued to the holder bears the Penn State® logo. Additionally or alternatively, in some embodiments, the organization determination is based at least partially on a determination that the rewards account holder has previously redeemed one or more rewards for one or more products, where those one or more products convey a brand associated with the organization. For example, in some embodiments, an account apparatus determines that a rewards account is associated with the Kansas City Royals® based at least partially on the apparatus determining that one or more rewards accumulated by the rewards account have been previously redeemed for one or more Kansas City Royals®-branded merchandise (e.g., Kansas City Royals® jerseys, baseball game tickets, etc.).

In addition to the method described above, other embodiments of the present invention provide an apparatus having: (a) a communication interface configured to receive, from a holder of a rewards account, a request for redemption information, where the rewards account is maintained by a financial institution; and (b) a processor operatively connected to the communication interface and configured to: (i) determine that the rewards account is associated with an organization, where the organization is not the financial institution, and where the organization is associated with a brand; and (ii) instruct the communication interface to present a redemption portal to the holder, where the redemption portal presents one or more products, and where the redemption portal has a theme that conveys the brand.

Still other embodiments of the present invention provide a computer program product having a non-transitory computer-readable medium, where the non-transitory computer-readable medium includes one or more computer-executable program code portions that, when executed by a computer, cause the computer to: (a) determine that a rewards account maintained by a financial institution is associated with an organization, where the organization is not the financial institution, and where the organization has a brand; and (b) present a redemption portal to a holder of the rewards account based at least partially on the computer determining that the rewards account is associated with the organization, where the redemption portal presents one or more products, and where the redemption portal is branded with the brand of the organization.

Other embodiments of the present invention provide another method that includes: (a) receiving, from a holder of a rewards account, a request for redemption information, where the rewards account is maintained by a financial institution; (b) determining, using a processor, that the rewards account is associated with an organization, where the organization is not the financial institution, and where the organization is associated with a brand; (c) retrieving one or more products from a library of products, where each of the one or more retrieved products conveys the brand; and (d) presenting, to the holder, a redemption portal having the one or more retrieved products.

### BRIEF DESCRIPTION OF THE DRAWINGS

Having thus described some embodiments of the present invention in general terms, reference will now be made to the accompanying drawings, where:

FIG. 1 is a flow diagram illustrating a general process flow for presenting a branded redemption portal to a holder of a rewards account, in accordance with an embodiment of the present invention;

FIG. 2 is a flow diagram illustrating a more-detailed process flow for presenting a branded redemption portal to a holder of a rewards account, in accordance with an embodiment of the present invention;

FIG. 3 is a block diagram illustrating technical components of a system for creating, storing, and/or presenting one or more branded redemption portals, in accordance with an embodiment of the present invention;

FIG. 4 is a mixed block and flow diagram of a system for presenting a pre-customized redemption portal to a rewards checking account holder, in accordance with an embodiment of the present invention;

FIG. 5 is a mixed block and flow diagram of a system for presenting a personalized redemption portal to a rewards credit card account holder, in accordance with an embodiment of the present invention; and

FIG. 6 illustrates an exemplary branded redemption portal, in accordance with an embodiment of the present invention.

### DETAILED DESCRIPTION OF EMBODIMENTS OF THE PRESENT INVENTION

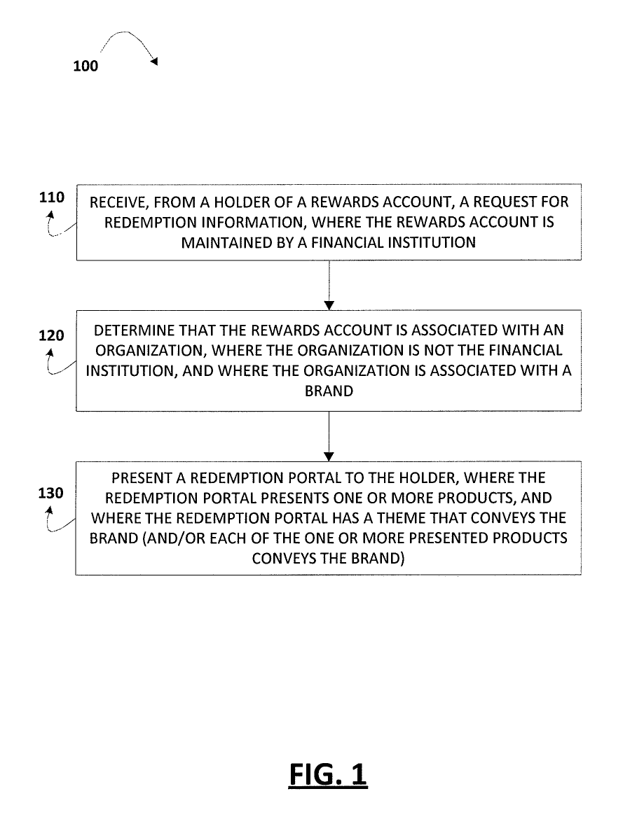

Referring to FIG. 1, a general process flow 100 is provided for presenting a branded redemption portal to a holder of a rewards account, in accordance with an embodiment of the present invention. In some embodiments, the process flow 100 is performed by an apparatus (i.e., one or more apparatuses) having hardware and/or software configured to perform one or more portions of the process flow 100. In such embodiments, as represented by block 110, the apparatus is configured to receive, from a holder of a rewards account, a request for redemption information, where the rewards account is maintained by a financial institution. As represented by block 120, the apparatus is also configured to determine that the rewards account is associated with an organization, where the organization is not the financial institution, and where the organization is associated with a brand. In addition, as represented by block 130, the apparatus is configured to present a redemption portal to the holder, where the redemption portal presents one or more products, and where the redemption portal has a theme that conveys the brand (and/or each of the one or more presented products conveys the brand).

For simplicity, it will be understood that the portion of the process flow represented by block 120 is sometimes referred to herein as the “organization determination.” In addition, it will be understood that the term “determine,” as used herein, is meant to have its one or more ordinary meanings (i.e., its ordinary dictionary definition(s)), but that in other embodiments, that term is meant to have one or more of the ordinary meanings of one or more of the following terms: decide, conclude, verify, ascertain, find, discover, learn, calculate, observe, read, and/or the like. In addition, in some embodiments, the phrase “based at least partially on” is meant to have one or more of its ordinary meanings, but in other embodiments, that is meant to have one or more of the ordinary meanings of one or more of the following terms and/or phrases: in response to, because of, after, when, if, as a result of, and/or the like.

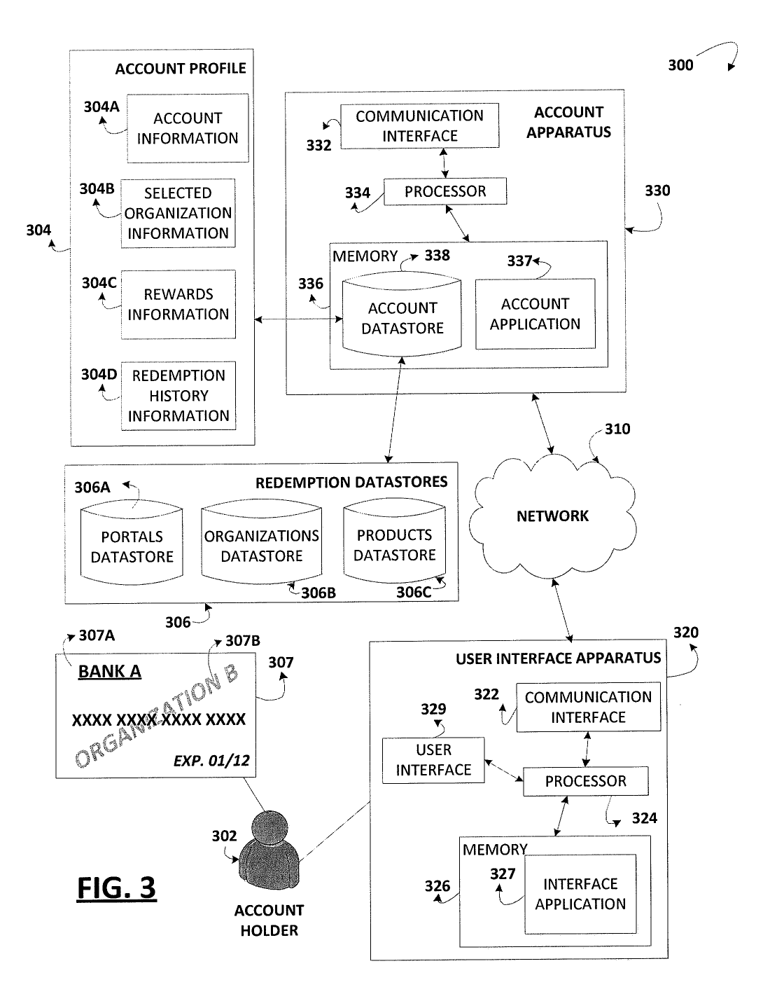

It will be understood that the apparatus having the process flow 100 can include one or more separate and/or different apparatuses. For example, in some embodiments, one apparatus (e.g., the user interface apparatus 320 described in connection with FIG. 3, etc.) is configured to perform the portion of the process flow 100 represented by block 110, and a second apparatus (e.g., the account apparatus 330) is configured to perform the portions represented by blocks 120 and 130. As still another example, in some embodiments, a single apparatus (e.g., the account apparatus 330) is configured to perform each and every portion of the process flow 100.

Regarding block 110, the rewards account generally refers to any deposit and/or credit account that can accumulate one or more rewards (e.g., points, miles, rewards dollars, credits, etc.). In some embodiments, the rewards account accumulates rewards as a result of the holder using the rewards account to engage in one or more transactions. In other embodiments, the rewards account additionally or alternatively accumulates rewards as a result of the customer maintaining a predetermined available balance and/or available credit for the rewards account (e.g., keeping the average available balance of a rewards checking account above $500 for three months). In still other embodiments, the rewards account may accumulate rewards as a result of the holder holding the rewards account for a predetermined period of time. It will also be understood that the rewards account referred to in block 110 can include any number and/or type of rewards account(s). For example, in some embodiments, the rewards account includes a checking account, savings account, money market account, investment account, brokerage account, certificate of deposit account, credit card account, line of credit (LOC) account, store credit account, home equity line of credit (HELOC) account, and/or any other deposit and/or credit account that can accumulate one or more rewards.

Also regarding block 110, the phrase “request for redemption information” is meant to be understood in its broadest sense. In some embodiments, the rewards account holder submits a request for redemption information by indicating the holder's intention to redeem one or more rewards for the one or more products. For example, in some embodiments, where the rewards account is associated with a mobile banking account, the holder may select a “Redeem Rewards” button displayed in a graphical user interface associated with the mobile banking account to indicate the holder's intention to redeem one or more rewards for one or more products. In other embodiments, the holder submits a request for redemption information by indicating his intention to view the one or more products. For example, in some embodiments, the holder selects a “View Rewards Merchandise” link displayed on a Bank website to indicate his intention to navigate to a web page that displays information associated with the one or more products. In still other embodiments, the holder submits a request for redemption information simply by indicating an intention to receive information associated with the rewards account (e.g., available balance, transaction history, etc.) and/or to receive information associated with the one or more rewards (e.g., rewards balance, terms/conditions placed on redeeming the rewards, etc.) that are associated with the rewards account. For example, in some embodiments, where the rewards account is associated with an online banking account, the holder submits a request for redemption information by logging in to the online banking account and/or navigating to a page that displays rewards information for the rewards account. As another example, in some embodiments, the holder submits a request for redemption information by placing a telephone call to a call center to inquire about the rewards account and/or the accumulated rewards.

Further regarding block 110, in some embodiments, the apparatus having the process flow 100 is controlled, serviced, owned, operated, managed, and/or otherwise maintained (sometimes collectively referred to herein as “maintained” for simplicity) by a financial institution (e.g., bank, credit card provider, mortgage lender, student loan company, etc.). In some embodiments, the financial institution that maintains the apparatus having the process flow 100 is the same financial institution that maintains the rewards account referred to in block 110.

Regarding block 120, the apparatus having the process flow 100 can be configured to make the organization determination based at least partially on receiving the request for redemption information. Also, the organization associated with the rewards account can be any charity, sports team, college, airline, retailer, and/or any other for-profit or non-profit organization. Exemplary organizations include, but are not limited to, Ducks Unlimited®, Make-A-Wish® Foundation, Penn State® University, Bass Pro Shops®, Kansas City Royals®, Alaska Airlines®, and/or the like. In some embodiments, the organization referred to in block 120 has partnered with the financial institution referred to in block 120 to provide organization-branded account materials (e.g., debit/credit cards, statements, checkbooks, etc.), organization-branded redemption portals, and/or organization-branded products (e.g., mugs, t-shirts, gift cards, etc.). In some of these embodiments, the organization is regarded as an “Affinity Partner” and/or an “Affiliate” of the financial institution by virtue of its participation and/or involvement in the redemption process represented by process flow 100.

Also, it will be understood that the financial institution that maintains the rewards account is not the organization that is associated with the rewards account. For example, in some embodiments, the rewards account is maintained by a bank (e.g., Bank of America®) and is associated with an organization that is not a bank (e.g., Ducks Unlimited®, Kansas City Royals®, Make-A-Wish® Foundation, etc.). Of course, this is not to say that the organization associated with the rewards account cannot be a financial institution. For example, in some embodiments, the rewards account is maintained by a first financial institution (e.g., Bank of America®) but is associated with a second financial institution (e.g., Merrill Lynch®). As a result, in such embodiments, the account materials associated with the rewards account and/or the presented redemption portal may each have a theme that conveys the Merrill Lynch® brand.

In some alternative embodiments, the rewards account is associated with multiple organizations, and the redemption portal has one or more themes that convey one or more brands associated with those multiple organizations. In other embodiments, the rewards account is associated with a single organization, and the redemption portal has one or more themes that convey multiple brands associated with that single organization. In addition, with reference to block 130, the one or more presented products may convey one or more brands associated with multiple organizations, and/or the presented products may convey multiple brands associated with a single organization.

Referring again to block 120, the apparatus having the process flow 100 can make the organization determination in any way. In some embodiments, the apparatus is configured to make the organization determination based at least partially on information stored in an account profile, where the account profile is associated with the rewards account. For example, after the organization is associated with the rewards account (e.g., after the holder selects the organization), the apparatus having the process flow 100 may store information about the organization in the account profile for the rewards account. This information may include, for example, the name (e.g., Bass Pro Shops®) of the organization and/or the brand(s) associated with the organization (e.g., the “Bass Pro Shops®” name, the fish design trademark owned by Bass Pro Shops®). As a result, in such embodiments, the apparatus may access the account profile and make the organization determination based at least partially on the information stored therein.

Additionally or alternatively, in some embodiments, the apparatus is configured to make the organization determination based at least partially on a determination (e.g., by the apparatus having the process flow 100, by another apparatus, by a human, etc.) that a debit/credit card, statement, and/or other account materials associated with the rewards account convey the brand associated with the organization. For example, in some embodiments, where the rewards account is a rewards checking account, the apparatus is configured to determine that the rewards checking account is associated with the Kansas City Royals® based at least partially on the apparatus determining that a debit card associated with the rewards checking account is branded with the Kansas City Royals® logo.

In other embodiments, the apparatus having the process flow 100 is configured to make the organization determination based at least partially on a redemption history associated with the rewards account. More specifically, in some embodiments, the apparatus is configured to make the organization determination based at least partially on a determination that the holder had previously redeemed rewards for products that convey the brand associated with the organization. For example, in some embodiments, the apparatus is configured to determine that the rewards account is associated with the Kansas City Royals® based at least partially on a determination that the holder has previous redeemed rewards for a Kansas City Royals® jersey and tickets to a Kansas City Royals® baseball game.

In still other embodiments, the apparatus having the process flow 100 is configured to make the organization determination based at least partially on a determination that the holder selected the organization for association with the account. For example, in some embodiments, the apparatus having the process flow 100 is configured to determine that the rewards account is associated with the Kansas City Royals® based at least partially on a determination that the holder selected the Kansas City Royals® for association with the rewards account (e.g., when the rewards account was opened). In some embodiments, information about the holder's section is stored in the account profile for the rewards account.

Further regarding block 120, the term “brand” generally refers to one or more names, signs, symbols, trademarks, slogans, jingles, music, sounds, and/or one or more other visual and/or audible indicators and/or identifiers that the organization uses to identify itself and/or its products to consumers. For example, in some embodiments, where the organization is Bass Pro Shops®, a brand associated with Bass Pro Shops® is the name “Bass Pro Shops®.” As another example, in some embodiments, where the organization is the Kansas City Royals®, a brand associated with the Kansas City Royals® is its distinctive blue scoreboard with gold crown logo. As still another example, in some embodiments, where the organization is Penn State® University, a brand associated with Penn State® University is the official fight song associated with Penn State® University.

Regarding block 130, the apparatus having the process flow 100 can be configured to present the redemption portal to the holder based at least partially on receiving the request for redemption information and/or based at least partially on making the organization determination. Further, the redemption portal can include any type and/or number of user interface(s). In some embodiments, the redemption portal is embodied as software and/or hardware. For example, in some embodiments, the redemption portal refers to hardware, such as one or more user output devices (e.g., displays, speakers, etc.) configured to present (e.g., render, display, output, etc.) information to the holder of the rewards account and/or one or more user input devices (e.g., buttons, keys, microphones, touchscreens, etc.) configured to receive information from the holder. In some embodiments, the redemption portal is embodied in and/or as the apparatus having the process flow 100. In other embodiments, the redemption portal is housed in a user interface apparatus (e.g., mobile phone, personal computer, ATM, etc.) that is operatively connected to the apparatus having the process flow 100.

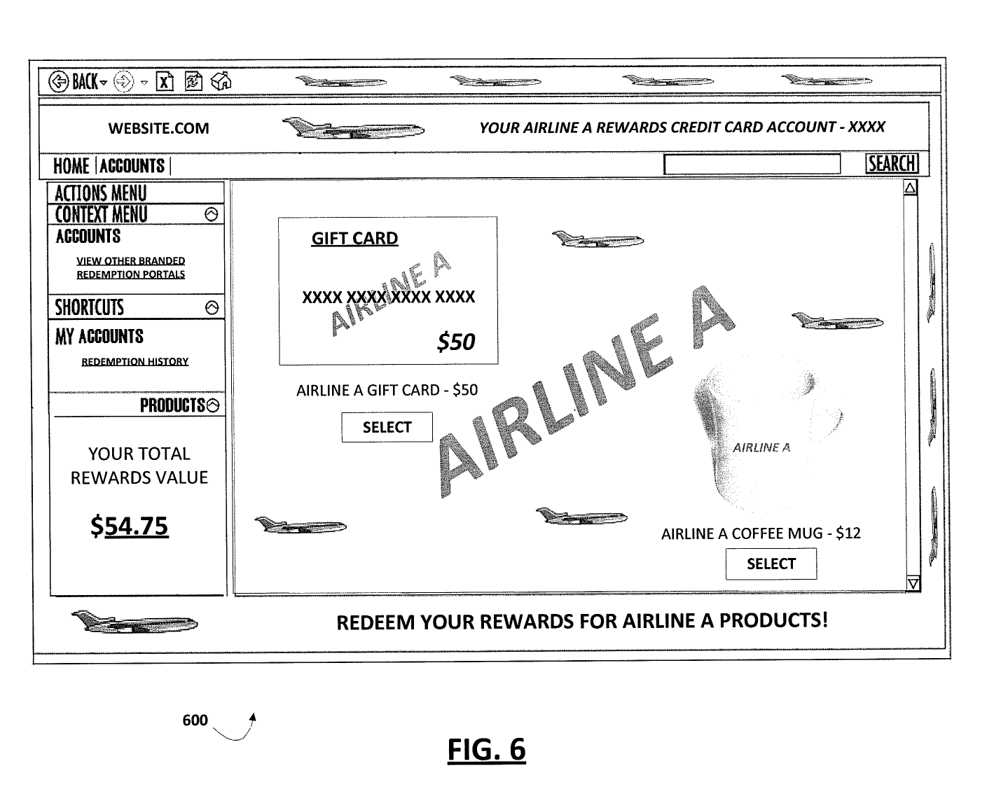

Additionally or alternatively, in some embodiments, the redemption portal refers to software, such as, for example, a web browser, web page, dashboard interface, and/or some other type of graphical user interface (GUI) and/or text-based user interface. In some embodiments, the redemption portal refers to a user interface that is associated with an electronic banking application (e.g., online banking application, mobile banking application, text banking application, account opening/enrollment application, etc.). For example, in some embodiments, the apparatus having the process flow 100 is configured to present (e.g., render, output, display, etc.) the redemption portal 600 illustrated in FIG. 6 to the holder of the rewards account.

In some embodiments, the redemption portal conveys information visually to the holder of the rewards account. For example, in some embodiments, the redemption portal is embodied as a GUI that visually displays one or more words, text, slogans, signs, symbols, colors, trademarks, and/or other information. In some embodiments, the redemption portal is embodied as a GUI that includes one or more features and/or formatting, including, for example, one or more windows, words, backgrounds, wallpapers, scroll bars, cursors, buttons, links, drop-down menus, and/or the like. In some embodiments, this visually displayed information (and/or the features and/or formatting) has a theme that conveys the brand associated with the organization. For example, in some embodiments, the redemption portal conveys a Penn State® theme, such that the portal has a blue and white-colored background, a Nittany Lion®-decorated wallpaper, and a window bearing the greeting, “Redeem Your Rewards for Penn State® Merchandise!”

Additionally or alternatively, in some embodiments, the redemption portal audibly conveys information to the holder of the rewards account. For example, in some embodiments, the redemption portal is embodied as software and/or hardware that sends and/or receives one or more IVR communications to the holder, where the IVR communications audibly convey one or more sounds, music, jingles, sayings, voices, and/or the like. For example, in some embodiments, an IVR communication conveys information associated with the rewards account, the rewards accumulated, and/or the one or more products available for selection. In some embodiments, these one or more audible outputs convey the brand associated with the organization. For example, in some embodiments, the redemption portal outputs the fight song associated with Penn State® University to convey the Penn State® brand.

In some embodiments, the redemption portal is operable to enable the holder to open the rewards account, manage the rewards account, and/or view information associated with the rewards account. Additionally or alternatively, in some embodiments, the redemption portal enables the holder to redeem one or more rewards for one or more products, to view those one or more products, and/or to view information associated with the rewards (e.g., rewards balance, redemption history, rules and regulations of the redemption process, etc.).

Further regarding block 130, in some embodiments, the one or more products that are presented via the redemption portal convey a brand associated with the organization. In some embodiments, the brand is conveyed because the one or more presented products include, bear, embody, project, communicate, express, present, disclose, impart, reveal, and/or otherwise convey the brand to a consumer (e.g., the holder of the rewards account). For example, in some embodiments, where the one or more presented products convey a brand associated with Ducks Unlimited®, the one or more products bear the name “Ducks Unlimited®” on the products. As another example, in some embodiments, where the one or more products convey a brand associated with Bass Pro Shops®, the one or more presented products display the distinctive fish design associated with, and trademarked by, Bass Pro Shops®. It will be understood that the one or more products can include any merchandise and/or any one or more goods and/or services, including, for example, t-shirts, mugs, tickets, blankets, gift cards, songs, donations to predetermined charities, and/or the like. As a specific example, in some embodiments, where the organization is Penn State® University, the redemption portal presents one or more Penn State®-branded products, such as, for example, a Nittany Lion® stuffed animal (i.e., the Penn State® University mascot), tickets to a Penn State® football game, and/or a poster illustrating the campus of Penn State® University.

In some embodiments, every product presented through the portal conveys a brand associated with the same organization. In some of these embodiments, every presented product conveys the exact same brand (e.g., the Bass Pro Shops® name). However, in other embodiments, the presented products may convey different types of brands associated with the same organization (e.g., one presented product bears the Bass Pro Shops® name and another presented product has the distinctive Bass Pro Shops® logo). However, in other embodiments, the redemption portal may present several products that convey brands associated with several different organizations (e.g., one presented product bears the Bass Pro Shops® name and another presented product bears the Make-A-Wish® Foundation name).

It will be understood that the apparatus having the process flow 100 can be configured to perform any of the portions of the process flow 100 represented by blocks 110-130 upon or after one or more triggering events (which, in some embodiments, is one or more of the other portions of the process flow 100). As used herein, a “triggering event” refers to an event that automatically (i.e., without human intervention) triggers the execution, performance, and/or implementation of a triggered action, either immediately, nearly immediately, or sometime after (e.g., within minutes, etc.) the occurrence of the triggering event. For example, in some embodiments, the apparatus having the process flow 100 is configured such that the apparatus making the organization determination (the triggering event) automatically and immediately or nearly immediately (e.g., within 3-30 seconds, etc.) triggers the apparatus to present the branded redemption portal and/or the one or more branded products to the holder (the triggered action(s)). In some embodiments, the apparatus is additionally or alternatively configured to make the organization determination (triggered action) automatically and immediately or nearly immediately after receiving the holder's request for redemption information (triggering event).

In accordance with some embodiments, the apparatus having the process flow 100 is configured to automatically perform one or more of the portions of the process flow 100 represented by blocks 110-130, whereas in other embodiments, one or more of the portions of the process flow 100 represented by blocks 110-130 require and/or involve human intervention (e.g., a user operating the apparatus). In addition, it will be understood that, in some embodiments, the apparatus having the process flow 100 (and/or a user thereof) is configured to perform one or more portions (or combinations of portions) of the process flow 100, from start to finish, within moments, seconds, and/or minutes (e.g., within approximately 1-15 minutes from start to finish, etc.).

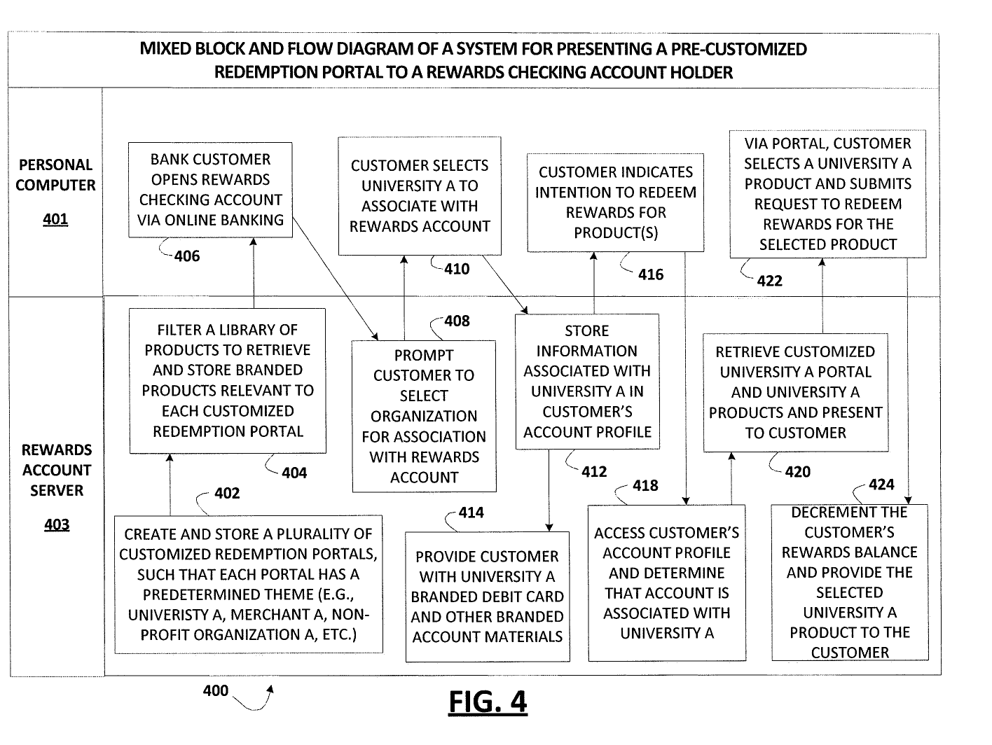

The apparatus having the process flow 100 can be configured to perform one or more portions of any embodiment described and/or contemplated herein, such as, for example, one or more portions of the process flow 200 described herein and/or one or more portions of the process flows described in connection with FIGS. 4 and/or 5. Also, the number, order, and/or content of the portions of the process flow 100 are exemplary and may vary. For example, in some alternative embodiments, before the organization is associated with the rewards account, the apparatus having the process flow 100 is configured to present a user interface (e.g., a web-based GUI) to the holder of the rewards account, where the user interface prompts (and/or enables) the holder to select an organization for association with the rewards account. As another example, in some alternative embodiments, the apparatus is configured to: (a) receive information indicating the holder has selected a product to receive in exchange for redeeming one or more rewards; and (b) provide (and/or instruct another apparatus to provide) the selected product to the holder. As a further example, in some embodiments, the apparatus is configured to identify and/or authenticate (e.g., confirm the identity of) the holder as a condition of receiving the holder's request and/or presenting the redemption portal. In some embodiments, the apparatus is configured to authenticate the holder based at least partially on a debit/credit card, account number, username, password, PIN, biometric information, barcode, and/or other credential the holder inserts, provides, and/or presents to the apparatus having the process flow 100. As still another example of an alternative embodiment, in some embodiments, the apparatus is configured to present a redemption portal to the holder of the rewards account, where the portal displays one or more products that convey the brand associated with the organization, but where the portal itself does not convey the brand associated with the organization (e.g., the redemption portal is “unbranded” and/or is a “plain” portal, etc.). In other embodiments, the redemption portal has a theme that conveys the brand, but the one or more products presented through the portal do not convey the brand (e.g., the presented product(s) are “unbranded” or the presented product(s) convey one or more brands associated with one or more other organizations, etc.).

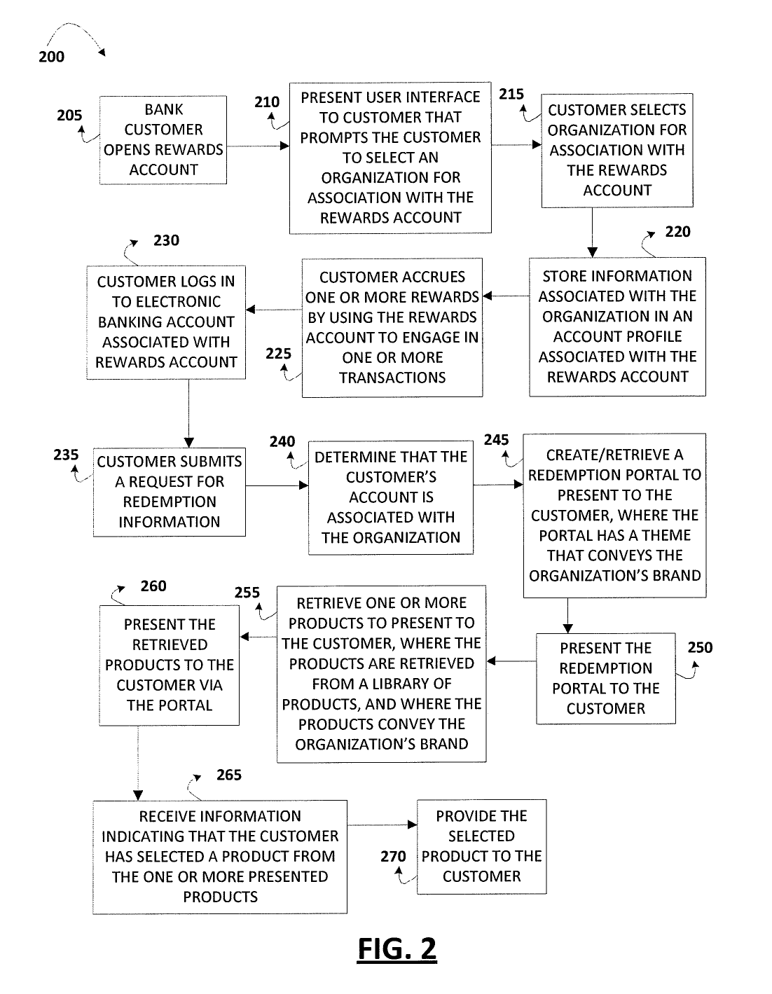

Referring now to FIG. 2, a more-detailed process flow 200 is provided for creating and presenting a branded redemption portal, in accordance with an embodiment of the present invention. It will be understood that the process flow 200 illustrated in FIG. 2 represents an example embodiment of the process flow 100 described in connection with FIG. 1. In accordance with some embodiments, one or more portions of the process flow 200 are performed by an apparatus having hardware and/or software configured to perform one or more portions of the process flow 200. In accordance with some embodiments, the apparatus having the process flow 200 is maintained by a bank for the benefit of its customers. Also in accordance with some embodiments, the customer referred to in the process flow 200 is a customer of the bank. In addition, the rewards account referred to in the process flow 200 is an account held by the customer and maintained by the bank.

As represented by block 205, the bank customer opens a rewards account (e.g., rewards credit card account, rewards HELOC account, rewards checking account, etc.). As represented by block 210, the apparatus having the process flow 200 presents a user interface to the customer that prompts and/or enables the customer to select an organization for association with the rewards account. In some embodiments, the user interface displays a plurality of organizations (e.g., Ducks Unlimited®, Penn State University®, Kansas City Royals®, etc.) from which the customer can select. Thereafter, as represented by block 215, the customer selects, via the user interface, an organization for association with the rewards account. Afterwards, as represented by block 220, the apparatus stores information associated with the selected organization in an account profile, where the account profile is associated with the rewards account. For example, in some embodiments, the apparatus stores, in the account profile, the name (e.g., Bass Pro Shops®) of the organization and the brand(s) associated with the organization (e.g., the “Bass Pro Shops®” name, the fish design trademark owned by Bass Pro Shops®).

In this example embodiment, after the customer opens the rewards account and has selected the organization for association with the account, the customer engages in one or more transactions using the rewards account, and, as a result, the rewards account earns, accrues, and/or otherwise accumulates one or more rewards, as represented by block 225. At some point after accumulating the rewards, the customer log in to an electronic banking account (e.g., online banking account, mobile banking account, etc.) associated with the rewards account, as represented by block 230. In some embodiments, during the login process, the apparatus having the process flow 200 authenticates the customer based at least partially on a username/password, PIN, account number, and/or other credential the customer presents to the apparatus.

As represented by block 235, after logging in to the electronic banking account, the customer submits a request for redemption information. For example, in some embodiments, the customer selects a “Redeem Rewards” button displayed via a graphical user interface associated with the electronic banking account. After receiving the customer's request, the apparatus having the process flow 200 makes the organization determination, as represented by block 240. For example, in some embodiments, the apparatus makes the organization determination based at least partially on a determination that the holder selected the organization for association with the account. As another example, in some embodiments, the apparatus makes the organization determination based at least partially on a determination that account materials (e.g., debit/credit card, statement, checkbook, etc.) associated with the rewards account convey the brand. As still another example, in some embodiments, the apparatus makes the organization determination based at least partially on a determination that one or more rewards associated with the rewards account have been previously redeemed for one or more products conveying the brand.

After making the organization determination, the apparatus is configured to create or retrieve a redemption portal, where the portal has a theme that conveys a brand associated with the organization, as represented by block 245. Thereafter, the apparatus is configured to present that portal to the customer (e.g., via the electronic banking account, via a GUI, etc.), as represented by block 250. In some embodiments, the branded redemption portal is created and stored in computer-readable memory before the holder opens the rewards account, before the holder selects the organization for association with the account, and/or before the holder submits the request for redemption information. In such embodiments, the apparatus having the process flow 200 is configured to retrieve the branded redemption portal from the computer-readable memory and then present the portal to the customer, all after, as a result of, and/or otherwise based at least partially on making the organization determination. However, in other embodiments, the apparatus is configured to create the branded redemption portal after, as a result of, and/or otherwise based at least partially on making the organization determination. In such embodiments, the apparatus receives the request for redemption information, makes the organization determination, creates the branded redemption portal, and then presents the portal to the customer, all within a short period of time (e.g., within a few seconds and/or minutes).

In addition to creating/retrieving and/or presenting the redemption portal, the apparatus having the process flow 200 is also configured to retrieve one or more products to present to the customer, where the one or more products are retrieved from a library of products, and where the one or more products convey the brand associated with the organization, as represented by block 255. For example, in some embodiments, where the selected organization is the Make-A-Wish® Foundation, the apparatus is configured to access a library of products associated with the redemption/rewards program and then filter that library of products to retrieve all of the Make-A-Wish®-branded products. After retrieving the products, the apparatus is configured to present information associated with the one or more retrieved products to the customer via the redemption portal, as represented by block 260. It will be understood that the portal and the product(s) may be presented to the customer at the same time. After being presented with the product(s), the apparatus having the process flow 200 receives information indicating that the customer has selected a product to receive in exchange for redeeming one or more rewards, as represented by block 265. Then, as represented by block 270, the apparatus is configured to provide (and/or instruct another apparatus and/or human to provide) the selected product to the customer.

Of course, it will be understood that the embodiment illustrated in FIG. 2 is merely exemplary and that other embodiments may vary without departing from the scope and spirit of the present invention. In addition, the apparatus having the process flow 200 can be configured to perform one or more portions of the process flow 200 in real time, in substantially real time, and/or at one or more predetermined times. The apparatus having the process flow 200 may be configured to perform any of the portions of the process flow 200 represented by blocks 205-270 upon or after one or more triggering events (which, in some embodiments, is the performance of one or more of the other portions of the process flow 200). In addition, in some embodiments, the apparatus having the process flow 200 (and/or a customer thereof) is configured to perform one or more portions (or combinations of portions) of the process flow 200, from start to finish, within moments, seconds, and/or minutes (e.g., within approximately 1-15 minutes, etc.).

Referring now to FIG. 3, a system 300 is provided for creating, storing, and/or presenting one or more branded redemption portals, in accordance with an embodiment of the present invention. As illustrated, the system 300 includes a network 310, a user interface apparatus 320, and an account apparatus 330. FIG. 3 also shows an account holder 302, a debit/credit card 307, an account profile 304, and redemption datastores 306. It will be understood that, in this example embodiment, the debit/credit card 307 is associated with a rewards account (e.g., rewards credit card account, rewards checking account, rewards HELOC account, etc.). In addition, the rewards account is held by the account holder 302, maintained by Bank A (e.g., Bank of America®), and associated with Organization B (e.g., Penn State® University, Ducks Unlimited®, Major League Baseball®, Bass Pro Shops®, Make-A-Wish® Foundation, Alaska Airlines®, etc.). As shown, the debit/credit card 307 is co-branded with the brand 307A of Bank A (e.g., name, logo, slogan, trademark, etc. associated with Bank A) and with the brand 307B of Organization B (e.g., name, logo, slogan, trademark, etc. associated with Organization B).

The account profile 304 shown in FIG. 3 is associated with the rewards account held by the holder 302. As shown in this example embodiment, the account profile 304 is stored in the account datastore 338 of the account apparatus 330. Also, as shown, the account profile 304 stores account information 304A (e.g., information associated with the rewards account), selected organization information 304B (e.g., information associated with Organization B), rewards information 304C (e.g., information associated with one or more rewards accumulated by the rewards account held by the holder 302), and redemption history information 304D (e.g., information associated with the redemption history of the rewards account). The account datastore 338 also stores redemption datastores 306, which includes a portals datastore 306A (e.g., storing information associated with one or more branded redemption portals, etc.), an organizations datastore 306B (e.g., storing information associated with one or more organizations for association with rewards accounts, etc.), and a products datastore 306C (e.g., storing information associated with one or more products that may be received by redeeming one or more rewards, etc.). As shown in this example embodiment, the holder 302 has access to the user interface apparatus 320 and to the debit/credit card 307. In some embodiments, the user interface apparatus 320 (e.g., personal computer, mobile phone, etc.) is maintained by the account holder 302, and the account apparatus 330 and the debit/credit card 307 is maintained by Bank A. However, in other embodiments, the account apparatus 330, the debit/credit card 307, and the user interface apparatus 320 (e.g., banking center kiosk, ATM, etc.) are all maintained by Bank A.

As shown in FIG. 3, the user interface apparatus 320 and the account apparatus 330 are each operatively and selectively connected to the network 310, which may include one or more separate networks. The network 310 may include one or more payment networks (e.g., interbank networks, Visa's® payment network VisaNet®, MasterCard's® payment network BankNet®, any wireline and/or wireless network over which payment information is sent, etc.), telephone networks (e.g., cellular networks, CDMA networks, any wireline and/or wireless network over which communications to telephones and/or mobile phones are sent, etc.), local area networks (LANs), wide area networks (WANs), global area networks (GANs) (e.g., the Internet, etc.), and/or one or more other telecommunications networks. It will also be understood that the network 310 may be secure and/or unsecure and may also include wireless and/or wireline technology.

The user interface apparatus 320 may include any computerized apparatus that can be configured to perform any one or more of the functions of the user interface apparatus 320 described and/or contemplated herein. It will also be understood that the user interface apparatus 320 can include and/or be embodied as any apparatus described and/or contemplated herein. It will further be understood that the user interface apparatus 320 can initiate, perform, complete, and/or otherwise facilitate any transaction described and/or contemplated herein as being initiated, performed, and/or otherwise facilitated by an apparatus. For example, in some embodiments, the user interface apparatus 320 includes and/or is embodied as a personal computer, PDA, mobile phone, gaming device, ATM, banking center kiosk, computer system, front end system, network device, and/or the like. As another example, in some embodiments, the user interface apparatus 320 is configured to initiate, perform, complete, and/or otherwise facilitate one or more financial and/or non-financial transactions, including, for example, purchasing, renting, selling, and/or leasing goods and/or services (e.g., groceries, stamps, tickets, gift certificates, DVDs, etc.); withdrawing cash; making deposits (e.g., cash, checks, etc.); making payments (e.g., paying telephone bills, sending remittances, etc.); redeeming one or more rewards for one or more products (sometimes referred to herein as “redemption transactions” for simplicity); accessing the Internet; and/or the like.

In some embodiments, the user interface apparatus 320 (and/or one or more other portions of the system 300) requires its users to authenticate themselves to the user interface apparatus 320 before the user interface apparatus 320 will initiate, perform, complete, and/or facilitate a transaction. For example, in some embodiments, the user interface apparatus 320 (and/or the interface application 327) is configured to authenticate a user based at least partially on an ATM/debit/credit card, loyalty/rewards/club card, smart card, token (e.g., USB token, etc.), username/password, personal identification number (PIN), biometric information, and/or one or more other credentials that the user presents to the user interface apparatus 320. Additionally or alternatively, in some embodiments, the user interface apparatus 320 is configured to authenticate a user by using one-, two-, or multi-factor authentication. For example, in some embodiments, the user interface apparatus 320 requires two-factor authentication, such that the holder 302 must provide a valid debit card and enter the correct PIN associated with the debit card in order to authenticate the holder 302 to the user interface apparatus 320.

As illustrated in FIG. 3, in accordance with some embodiments of the present invention, the user interface apparatus 320 includes a communication interface 322, a processor 324, a memory 326 having an interface application 327 stored therein, and a user interface 329. In such embodiments, the processor 324 is operatively and selectively connected to the communication interface 322, the user interface 329, and the memory 326.

Each communication interface described herein, including the communication interface 322, generally includes hardware, and, in some instances, software, that enables a portion of the system 300, such as the user interface apparatus 320, to send, receive, and/or otherwise communicate information to and/or from the communication interface of one or more other portions of the system 300. For example, the communication interface 322 of the user interface apparatus 320 may include a modem, network interface controller (NIC), near field communication (NFC) interface, network adapter, network interface card, and/or some other electronic communication device that operatively connects the user interface apparatus 320 to another portion of the system 300, such as, for example, the account apparatus 330.

Each processor described herein, including the processor 324, generally includes circuitry for implementing the audio, visual, and/or logic functions of that portion of the system 300. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the interface application 327 of the memory 326 of the user interface apparatus 320.

Each memory device described herein, including the memory 326 for storing the interface application 327 and other information, may include any computer-readable medium. For example, the memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of portions of information used by the apparatus in which it resides to implement the functions of that apparatus.

As shown in FIG. 3, the memory 326 includes the interface application 327. It will be understood that the interface application 327 can be operable (e.g., usable, executable, etc.) to initiate, perform, complete, and/or facilitate one or more portions of any embodiment described and/or contemplated herein, such as, for example, one or more portions of the process flows 100 and/or 200 described herein and/or one or more portions of the process flows described in connection with FIGS. 4 and/or 5. For example, in some embodiments, the interface application 327 is operable to submit and/or receive requests for redemption information (e.g., information associated with viewing and/or receiving one or more products in exchange for redeeming one or more rewards, etc.). As another example, in some embodiments, the interface application 327 is operable to make one or more organization determinations. As another example, in some embodiments, the interface application 327 is operable to receive, retrieve, create, and/or present, via the user interface 329, one or more redemption portals (e.g., the redemption portal 600 illustrated in FIG. 6) to the holder 302. As still another example, in some embodiments, the interface application 327 is operable to receive, via the user interface 329, the holder's 302 selection of one or more products to receive in exchange for redeeming one or more rewards. As yet another example, in some embodiments, the interface application 327 is operable to receive, filter, and/or retrieve one or more products (e.g., branded, unbranded, etc.) to present to the holder 302 via one or more redemption portals. As another example, in some embodiments, the interface application 327 and/or the user interface apparatus 320 is operable and/or configured to provide (and/or instruct another apparatus to provide the holder 302 with a product that the holder 302 selects in exchange for redeeming one or more rewards. For example, in some embodiments, if the holder 302 selects a gift card to receive in exchange for redeeming one or more rewards, the interface application 327 and/or user interface apparatus 320 is operable and/or configured to dispense, order, email, print, and/or otherwise provide the gift card to the holder 302. As another example, in some embodiments, the interface application 327 is embodied as an electronic banking application (e.g., online banking application, mobile banking application, etc.) that is operable to enable the holder 302 to initiate, perform, complete, and/or otherwise facilitate one or more redemption transactions and/or other banking transactions (e.g., transfer funds, check account balances, etc.).

In some embodiments, where the user interface apparatus 320 includes and/or is embodied as an ATM, the interface application 327 is configured to execute on the ATM in order to initiate, perform, complete, and/or facilitate, for example, one or more redemption transactions, cash withdrawals, deposits, and/or the like. In other embodiments, where the user interface apparatus 320 includes and/or is embodied as a mobile phone, the interface application 327 is configured to execute on the mobile phone in order to access a mobile banking account and/or to initiate, perform, complete, and/or facilitate, for example, one or more redemption transactions, funds transfers, etc. In still other embodiments, where the user interface apparatus 320 includes and/or is embodied as a personal computer, the interface application 327 is configured to execute on the personal computer, and, in some embodiments, the interface application 327 is embodied as a web browser (i.e., for navigating the Internet, accessing an online banking account, etc.) that is operable to initiate, perform, complete, and/or otherwise facilitate one or more redemption transactions, as well as other financial and/or non-financial transactions.

In some embodiments, the interface application 327 is operable to enable the holder 302 and/or user interface apparatus 320 to communicate with one or more other portions of the system 300, and/or vice versa. In some embodiments, the interface application 327 includes one or more computer-executable program code portions for causing and/or instructing the processor 324 to perform one or more of the functions of the interface application 327 and/or user interface apparatus 320 described and/or contemplated herein. In some embodiments, the interface application 327 includes and/or uses one or more network and/or system communication protocols.

As shown in FIG. 3, the user interface apparatus 320 also includes the user interface 329. It will be understood that the user interface 329 (and any other user interface described and/or contemplated herein) can include and/or be embodied as one or more user interfaces. It will also be understood that, in some embodiments, the user interface 329 includes one or more user output devices for presenting information and/or one or more items to the transaction machine user (e.g., the holder 302, etc.), such as, for example, one or more displays, speakers, receipt printers, dispensers (e.g., cash dispensers, ticket dispensers, merchandise dispensers, etc.), and/or the like. In some embodiments, the user interface 329 additionally or alternatively includes one or more user input devices, such as, for example, one or more buttons, keys, dials, levers, directional pads, joysticks, keyboards, mouses, accelerometers, controllers, microphones, touchpads, touchscreens, haptic interfaces, styluses, scanners, biometric readers, motion detectors, cameras, card readers (e.g., for reading the magnetic strip on magnetic cards such as ATM, debit, credit, and/or bank cards, etc.), deposit mechanisms (e.g., for depositing checks and/or cash, etc.), and/or the like for receiving information from one or more items and/or from the transaction machine user (e.g., the holder 302, etc.). In some embodiments, the user interface 329 and/or the user interface apparatus 320 includes one or more vaults, security sensors, locks, and/or anything else typically included in and/or near a transaction machine. In some embodiments, the user interface 329 is embodied as hardware and/or software.

FIG. 3 also illustrates an account apparatus 330, in accordance with an embodiment of the present invention. The account apparatus 330 may include any computerized apparatus that can be configured to perform any one or more of the functions of the account apparatus 330 described and/or contemplated herein. It will also be understood that the account apparatus 330 can include and/or be embodied as any apparatus described and/or contemplated herein. It will further be understood that the account apparatus 330 can initiate, perform, complete, and/or otherwise facilitate any transaction described and/or contemplated herein as being initiated, performed, and/or otherwise facilitated by an apparatus. In some embodiments, the account apparatus 330 includes and/or is embodied as one or more servers, engines, mainframes, computer systems, personal computers, ATMs, network devices, front end systems, back end systems, and/or the like. In some embodiments, such as the one illustrated in FIG. 3, the account apparatus 330 includes a communication interface 332, a processor 334, and a memory 336, which includes an account application 337 and an account datastore 338 stored therein. As shown, the communication interface 332 is operatively and selectively connected to the processor 334, which is operatively and selectively connected to the memory 336.

The account application 337 can be operable (e.g., usable, executable, etc.) to initiate, perform, complete, and/or facilitate any one or more portions of the process flows 100 and/or 200 described herein and/or one or more portions of the process flows described in connection with FIGS. 4 and/or 5. For example, in some embodiments, the account application 337 is operable to present a GUI (e.g., browser screen, web page) to the holder 302 via the user interface 329 of the user interface apparatus 320, where the GUI enables the holder to open a rewards account and select an organization (e.g., from the organizations datastore 306B, etc.) for association with the rewards account. As another example, in some embodiments, the account application 337 is operable to receive information indicating that the holder 302 has selected an organization (e.g., Organization B) for association with the rewards account.

In some embodiments, the account application 337 is also operable to receive, from the holder 302 via the user interface 329, a request for redemption information (e.g., a request to view one or more products and/or to redeem one or more rewards for one or more products, etc.). As another example, in some embodiments, the account application 337 is operable to determine that the rewards account held by the holder 302 is associated with an organization (e.g., Organization B). In some of these embodiments, the account application 337 is operable to make the organization determination based at least partially on a determination that the debit/credit card 307 conveys the brand 307B of the organization (e.g., by bearing the name of Organization B). In other embodiments, the account application 337 additionally or alternatively makes the organization determination based at least partially on a determination that the holder has previously redeemed one or more rewards for one or more products that convey the brand 307B of the organization (e.g., by accessing the redemption history information 304D, etc.). In still other embodiments, the account application 337 makes the organization determination based at least partially on accessing the selected organization information 304B of the holder's account profile 304 and identifying the name and/or brand 307B of the organization contained therein. In some embodiments, the account application 337 makes the organization determination based at least partially on a determination that the holder 302 selected the organization (e.g., Organization B) for association with rewards account.

As still another example, in some embodiments, the account application 337 is operable to create one or more branded redemption portals (e.g., the redemption portal 600) and/or store those branded redemption portals in the portals datastore 306A. Additionally or alternatively, in some embodiments, the account application 337 is operable to receive and/or retrieve one or more portals from the portals datastore 306A and present those one or more portals to the holder 302 via the user interface 329 of the user interface apparatus 320. As another example, in some embodiments, the account application 337 is operable to filter a library of products stored in the products datastore 306C to retrieve one or more products that convey the brand of a particular organization (e.g., the brand 307B Organization B). As still another example, in some embodiments, the account application 337 is operable to present the one or more products to the holder 302 via a branded or unbranded redemption portal. In some embodiments, the redemption portal and the one or more products are presented to the holder 302 at the same time.

In some embodiments, the account application 337 is operable to enable the account apparatus 330 to communicate with one or more other portions of the system 300, such as, for example, the account datastore 338 and/or the user interface apparatus 320, and/or vice versa. In addition, in some embodiments, the account application 337 is operable to initiate, perform, complete, and/or otherwise facilitate one or more redemption transactions, as well as one or more other financial and/or non-financial transactions. In some embodiments, the account application 337 includes one or more computer-executable program code portions for causing and/or instructing the processor 334 to perform one or more of the functions of the account application 337 and/or the account apparatus 330 that are described and/or contemplated herein. In some embodiments, the account application 337 includes and/or uses one or more network and/or system communication protocols.

In addition to the account application 337, the memory 336 also includes the account datastore 338. It will be understood that the account datastore 338 can be configured to store any type and/or amount of information. As shown, the account datastore 338 stores the account profile 304, which includes account information 304A, selected organization information 304B, rewards information 304C, and redemption history information 304D. The account information 304A may include any information associated with the rewards account held by the holder 302, including, for example, transaction information associated with one or more transactions involving the rewards account (e.g., date/time, description, transaction amount, etc.), information associated with one or more account holders (e.g., holder 302), information associated with one or more account preferences, billing information, and/or the like. The selected organization information 304B may include any information associated with the organization associated with the rewards account, including, for example, the brand 307B associated with the organization, when the organization was selected by the holder 302 for association with the rewards account, etc. The rewards information 304C may include any information associated with one or more rewards earned by the rewards account, including, for example, rewards balances (e.g., the dollar, point, credit, miles, and/or other value amount of the rewards accrued), the one or more reasons the rewards were earned (e.g., by using the account to engage in transactions, by holding the account for a predetermined period of time, etc.), and/or the like. The redemption history information 304D may include any information associated with one or more products that were received in exchange for redeeming one or more rewards, including, for example, the type of product(s), the brand conveyed by the product(s), the cost of the product(s) (e.g., in real terms, in rewards value, etc.), the date/time the product(s) were selected and/or provided, and/or the like.

The account datastore 338 also stores the redemption datastores 306, which includes the portals datastore 306A, the organizations datastore 306B, and the products datastore 306C. The portals datastore 306A may include any information associated with one or more redemption portals. For example, in some embodiments, the portals datastore 306A stores one or more pre-customized redemption portals, where each portal conveys the brand of a predetermined organization. As another example, in some embodiments, the portals datastore 306A stores computer-executable program code portions that, when executed by a processor and/or computer, cause the processor and/or computer to create a personalized redemption portal based at least partially on the redemption history of a particular rewards account and/or based at least partially on an organization associated with a particular rewards account. The organizations datastore 306B may include any information associated with one or more organizations that can be associated with one or more rewards accounts (e.g., Organization B). For example, in some embodiments, the organizations datastore 306B lists the names and brands of all of the organizations (e.g., Ducks Unlimited®, Make-A-Wish®, Bass Pro Shops®, etc.) that have partnered with Bank A (e.g., Bank of America®) to provide a branded redemption experience. The products datastore 306C may include any information associated with one or more products that can be received in exchange for redeeming one or more rewards. For example, in some embodiments, the products datastore 306C lists the images, descriptions, costs, and/or availability of the one or more products. In some embodiments, one or more of the products stored in the products datastore 306C convey a brand associated with an organization listed in the organizations datastore 306B. For example, in some embodiments, the products datastore 306C stores information associated with a plurality of Penn State®-branded products (e.g., mugs, t-shirts, gift cards, tickets, etc. that convey the Penn State® brand and/or are otherwise associated with Penn State® University, etc.), a plurality of Ducks Unlimited®-branded products, a plurality of Make-A-Wish®-branded products, and/or the like. In some embodiments, the one or more products listed in the products datastore 306C can be filtered to retrieve one or more products conveying one or more particular, predetermined brands.

In addition to the account profile 304 and the redemption datastores 306, the account datastore 338 may include information associated with one or more account holders (i.e., in addition to the holder 302), account profiles (i.e., in addition to the account profile 304), financial accounts (i.e., in addition to the rewards account held by the holder 302), electronic banking accounts (e.g., online banking accounts, mobile banking accounts, text banking accounts, etc.), user interface apparatuses, and/or the like. Also, the account datastore 338, the portals datastore 306A, the organizations datastore 306B, and the products datastore 306C may each include any one or more storage devices, including, but not limited to, datastores, databases, and/or any of the other storage devices typically associated with a computer system. It will also be understood that these datastores may store information in any known way, such as, for example, by using one or more computer codes and/or languages, alphanumeric character strings, data sets, figures, tables, charts, links, documents, and/or the like. Further, in some embodiments, the account datastore 338 includes information associated with one or more applications, such as, for example, the account application 337 and/or the interface application 327. In some embodiments, the account datastore 338 provides a real-time or near real-time representation of the information stored therein, so that, for example, when the processor 334 accesses the account datastore 338, the information stored therein is current or nearly current. Although not shown, in some embodiments, the user interface apparatus 320 may include a datastore that is configured to store any information associated with the user interface apparatus 320, the interface application 327, and/or the like. It will be understood that this datastore can store information in any known way, can include information associated with anything shown in FIG. 3, and/or can be configured similar to the account datastore 338.

The embodiment illustrated in FIG. 3 is exemplary and other embodiments may vary. For example, in some embodiments, some or all of the portions of the system 300 are combined into a single portion. Specifically, in some embodiments, the user interface apparatus 320 and the account apparatus 330 are combined into a single user interface and account apparatus that is configured to perform all of the same functions of those separate portions as described and/or contemplated herein. Likewise, in some embodiments, some or all of the portions of the system 300 are separated into two or more distinct portions. In addition, the various portions of the system 300 may be maintained by the same or separate parties.

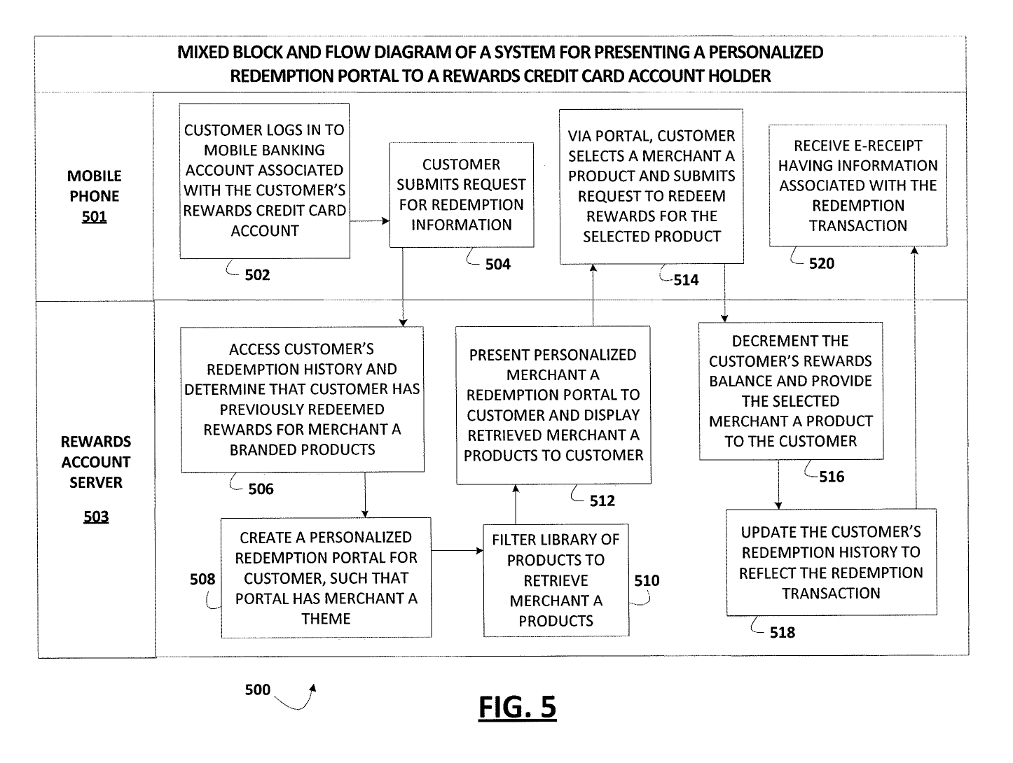

The system 300 and/or one or more portions of the system 300 may include and/or implement any embodiment of the present invention described and/or contemplated herein. For example, in some embodiments, the system 300 (and/or one or more portions of the system 300) is configured to implement any one or more embodiments of the process flow 100 described and/or contemplated herein in connection with FIG. 1, any one or more embodiments of the process flow 200 described and/or contemplated herein in connection with FIG. 2, any one or more embodiments of the process flow described and/or contemplated herein in connection with FIG. 4, any one or more of embodiments of the process flow described and/or contemplated herein in connection with FIG. 5, and/or any one or more of the embodiments described and/or contemplated herein in connection with FIG. 6.

As a specific example, in accordance with an embodiment of the present invention, the account apparatus 330 is configured to: (a) receive, from the holder 302 of the rewards account, a request for redemption information, where the rewards account is maintained by Bank A, as represented by block 110 in FIG. 1; (b) determine that the rewards account is associated with Organization B, where Organization B is not Bank A, and where Organization B is associated with a brand 307B (e.g., trademark, logo, name, etc. associated with Organization B), as represented by block 120; and (c) present, via the user interface 329 of the user interface apparatus 320, a redemption portal (e.g., created by the user interface apparatus 320, retrieved from the portals datastore 306A, etc.) to the holder 302 based at least partially on making the organization determination, where the redemption portal presents one or more products (e.g., retrieved from the products datastore 306C), and where the redemption portal has a theme that conveys the brand 307B associated with Organization B (e.g., the background, wallpaper, window, scroll bar, and/or cursor conveys the brand 307B, etc.), as represented by block 130. In accordance with some embodiments, the user interface apparatus 320 and the account apparatus 330 are each configured to send and/or receive one or more instructions to and/or from each other, such that an instruction sent, for example, from the account apparatus 330 to the user interface apparatus 320 (and/or vice versa) can trigger the user interface apparatus 320 (and/or vice versa) to perform one or more portions of any one or more of the embodiments described and/or contemplated herein.

Referring now to FIG. 4, a mixed block and flow diagram of a system 400 for presenting a pre-customized redemption portal to a rewards checking account holder is provided, in accordance with an exemplary embodiment of the present invention. It will be understood that the system 400 illustrated in FIG. 4 represents an example embodiment of the process flow 100 described in connection with FIG. 1. As shown, the system 400 includes a personal computer 401 (e.g., the user interface apparatus 320) and a rewards account server 403 (e.g., the account apparatus 330). The personal computer 401 and the rewards account server 403 may each include a communication interface, a user interface, a processor, a memory, an application, and/or a datastore, and those components may be operatively connected to each other. In accordance with some embodiments, the personal computer 401 is operatively and selectively connected to the rewards account server 403 via one or more networks (e.g., Internet). In this example embodiment, the personal computer 401 is accessible to a customer of a bank (e.g., the holder of the rewards checking account). Also, the personal computer 401 is maintained by the customer, and the rewards account server 403 is maintained by the bank. Further, in accordance with some embodiments, the bank maintains the rewards checking account held by the customer that is mentioned below.

As represented by block 402, the rewards account server 403 creates and stores a plurality of customized redemption portals, such that each portal has a predetermined theme (e.g., Penn State®, Bass Pro Shops®, Make-A-Wish®, etc.). For example, in some embodiments, each of these customized redemption portals has a theme that includes one or more backgrounds, wallpaper, scroll bars, windows, cursors, and/or one or more other features and/or formatting that convey a predetermined brand. In addition, as represented by block 404, the server 402 filters a library of products to retrieve and store branded products relevant to each customized redemption portal. Sometime thereafter, the bank customer logs in to an online banking account (e.g., which is associated with the customer's one or more other accounts) and opens a rewards checking account, as represented by block 406. Although not shown, as part of the login process, the server 403 may also identify and/or authenticate the customer based at least partially on one or more credentials (e.g., username/password, PIN, etc.) the customer provides to the server 403. Next, as represented by block 408, the rewards account server 403 prompts the customer to select an organization for association with the rewards account. After being prompted, the customer selects, in this example embodiment, Penn State® University for association with the rewards account, as represented by block 410. Thereafter, the rewards account server 403 stores information associated with the customer's selection (i.e., information associated with Penn State® University) in an account profile associated with the customer's rewards account, as represented by block 412. Then, the rewards account server 403 provides (and/or instructs another fulfillment apparatus to provide) the customer with a Penn State®-branded debit card and/or other branded account materials, as represented by block 414.

Sometime after being provided with the branded debit card, and after the customer has accumulated rewards by using the rewards checking account to engage in transactions, the customer uses the personal computer 401 to indicate his intention to redeem the rewards for one or more products (and/or to view the product(s) and/or to view information associated with the rewards checking account), as represented by block 416. Although not shown, in some embodiments, the customer indicates this intention via an online banking account associated with the rewards account, which may be the same or different than the online banking account referred to in block 406. After the customer indicates his intention to redeem, the rewards account server 403 accesses the customer's account profile and determines that the account is associated with Penn State® University, as represented by block 418. In addition, as represented by block 420, the server 403 retrieves the pre-customized Penn State®-branded portal (e.g., from the portals datastore 306A) and presents the portal to the customer. In addition, the server 403 retrieves and presents the stored Penn State® products (e.g., from the products datastore 306C, etc.) to the customer via the pre-customized Penn State® portal, as represented by block 420. Thereafter, as represented by block 422, the customer uses the portal to select a Penn State® product and to submit a request to redeem one or more rewards for that selected Penn State® product. After receiving the customer's request, the rewards account server 403 decrements the customer's rewards balance (e.g., by the rewards value or cost of the selected product) and provides the selected Penn State® product (and/or instructs a fulfillment apparatus to provide the product) to the customer, as represented by block 424.

Of course, the embodiment illustrated in FIG. 4 is merely exemplary and other embodiments may vary without departing from the scope and spirit of the present invention. Also, in some embodiments, one or more of the portions of the process flow represented by blocks 402-424 are triggered by one or more triggering events, which, in some embodiments, include the performance of one or more of the other portions of the process flow represented by blocks 402-424. Also, in some embodiments, the system 400 is configured to perform one or more portions (or combinations of portions) of the process flow represented by blocks 402-424, from start to finish, within moments, seconds, and/or minutes. For example, in some embodiments, the rewards account server 403 is configured to retrieve and present the customized Penn State® portal to the customer within approximately 1-60 seconds of the customer indicating his intention to redeem his rewards.

Referring now to FIG. 5, a mixed block and flow diagram of a system 500 for presenting a personalized redemption portal to a rewards credit card account holder is provided, in accordance with an exemplary embodiment of the present invention. It will be understood that the system 500 illustrated in FIG. 5 represents an example embodiment of the process flow 100 described in connection with FIG. 1. As shown, the system 500 includes a mobile phone 501 (e.g., the user interface apparatus 320) and a rewards account server 503 (e.g., the account apparatus 330). The mobile phone 501 and the rewards account server 503 may each include a communication interface, a user interface, a processor, a memory, an application, and/or a datastore, and those components may be operatively connected to each other.

In accordance with some embodiments, the mobile phone 501 is operatively and selectively connected to the rewards account server 503 via one or more networks (e.g., cellular data network, telephone network). In addition, the mobile phone 501 is accessible to the customer referred to in block 502. Also, in this example embodiment, the mobile phone 501 is maintained by the customer, and the rewards account server 503 is maintained by the customer's bank. Further, in accordance with some embodiments, the bank maintains the rewards credit card account held by the customer that is mentioned below. Also, in this example embodiment, it will be understood that the customer has already opened the rewards credit card account before the performance of the process flow shown in FIG. 5.

As represented by block 502, the customer uses the mobile phone 501 to log in to a mobile banking account that is associated with his rewards credit card account. In some embodiments, the mobile banking account is accessible through a mobile banking application that is installed and executes on the mobile phone 501. In some embodiments, the mobile phone 501, the mobile banking application, and/or the rewards account server 503 authenticates the customer before the customer is provided access to the mobile banking account. In some embodiments, the mobile banking application authenticates the customer based at least partially on one or more credentials provided by the customer (e.g., username, password, account number, etc.). After logging in, the customer submits a request for redemption information, as represented by block 504. For example, in some embodiments, the customer selects a “Redeem Now” button to indicate that the customer wishes to redeem one or more rewards for one or more products (and/or to view those one or more products). After the customer submits the request, the rewards account server 503 accesses the customer's redemption history (e.g., redemption history information 304D in the account profile 304, etc.) and determines that the customer has previously redeemed one or more rewards for one or more Bass Pro Shops® branded products, as represented by block 506. As a result, the rewards account server 503 creates a personalized redemption portal for the customer, such that the portal has a Bass Pro Shops® theme, as represented by block 508. For example, in some embodiments, the personalized redemption portal includes a Bass Pro Shops®-branded window, background, and scroll bar. In addition, as represented by block 510, the server 503 filters a library of products to retrieve one or more Bass Pro Shops®-branded products from the library. Thereafter, as represented by block 512, the rewards account server 503 presents the personalized Bass Pro Shops® redemption portal to the customer via the mobile phone 501 and/or the mobile banking application. In addition, the server 503 also displays the retrieved Bass Pro Shops® products to the customer via the mobile phone 501. For example, in some embodiments, the portal and retrieved products are presented visually to the customer via a display of the mobile phone 501 and/or audibly via a speaker of the mobile phone 501. After reviewing the portal and the products, the customer selects a Bass Pro Shops®-branded product and submits a request, to the server 503, to redeem one or more rewards for that selected Bass Pro Shops®-branded product, as represented by block 514. For example, in some embodiments, the customer selects a digital button displayed on the touchscreen display of the mobile phone 501 and/or uses a stylus associated with the mobile phone 501 to indicate, via the mobile phone 501 and the personalized redemption portal, that the customer wishes to redeem the rewards for the selected Bass Pro Shops® product (e.g., a Bass Pro Shops®-branded fishing pole, etc.).

After the customer selects the branded product and submits the redemption request, the rewards account server 503 decrements the customer's rewards balance (e.g., by the rewards value of the selected product) and provides the selected Bass Pro Shops® product to the customer, as represented by block 516. In addition, as represented by block 518, the server 503 updates the customer's redemption history to reflect the redemption transaction. For example, in some embodiments, the server 503 stores information associated with the selected Bass Pro Shops® product and/or information associated with the Bass Pro Shops® organization and/or brand in an account profile associated with the customer's rewards credit card account. As represented by block 520, the rewards account server 503 also generates and sends an electronic receipt associated with the redemption transaction to the mobile phone 501 (e.g., via email, instant notification, text message, etc.). In some embodiments, this electronic receipt may include information about the redemption transaction (e.g., rewards amount redeemed, description of the selected Bass Pro Shops® product, the date/time of the redemption transaction, etc.). In some embodiments, the rewards account server 503 additionally or alternatively posts information associated with the redemption transaction to the mobile banking account associated with the rewards credit card account.

Of course, the embodiment illustrated in FIG. 5 is merely exemplary and other embodiments may vary without departing from the scope and spirit of the present invention. For example, in some embodiments, one or more portions of the process flow being performed by the rewards account server 503 are performed instead by the mobile phone 501, and/or vice versa. Also, in some embodiments, one or more of the portions of the process flow represented by blocks 502-520 are triggered by one or more triggering events, which, in some embodiments, include the performance of one or more of the other portions of the process flow represented by blocks 502-520. Also, in some embodiments, the system 500 is configured to perform the entire process flow represented by blocks 502-520, from start to finish, within moments, seconds, and/or minutes. For example, in some embodiments, the rewards account server 503 creates and presents the personalized redemption portal and branded products to the customer, as represented by block 512, within approximately 1-45 seconds of the server 503 receiving the redemption information request from the mobile phone 501.

Referring now to FIG. 6, an exemplary branded redemption portal 600 is illustrated, in accordance with an embodiment of the present invention. As shown, the redemption portal 600 is embodied as a graphical user interface (e.g., browser screen, web page, dashboard interface, etc.) associated with an online banking account. The online banking account is associated with a rewards credit card account that is identified at the top of the portal 600 (e.g., the Airline XYZ rewards credit card account—3471). Also as shown, the redemption portal 600 has a theme that conveys a brand associated with the organization “Airline XYZ.” It will be understood that, in this example embodiment, Airline XYZ is the organization that is associated with the rewards account. The redemption portal 600 illustrates two types of brands associated with Airline XYZ, including an airplane logo (e.g., displayed in the lower left hand corner of the portal 600, displayed along the right hand side of the portal 600, etc.) and the name “Airline XYZ” (e.g., displayed as the background and/or wallpaper for the portal 600, displayed in a greeting shown at the bottom of the portal 600, etc.).

The redemption portal 600 also displays two products that can be received in exchange for redeeming the rewards of the rewards account, including a $12 coffee mug and a $50 gift card. These products can be selected (e.g., by the holder of the rewards account) by using the “Select” buttons displayed in the portal 600 proximate the products. The redemption portal 600 also illustrates information identifying the rewards account (e.g., the identifier “Your Airline XYZ rewards credit card account—3471”) and information identifying the total rewards value associated with that rewards account (e.g., “$54.75”). In addition, the redemption portal 600 illustrates a selectable link to view redemption history associated with the rewards account and a selectable link to view other branded redemption portals (e.g., a redemption portal having a theme that conveys the brand associated with Ducks Unlimited®). It will be understood that any apparatus described and/or contemplated herein (e.g., account apparatus 330, user interface apparatus 320, personal computer 401, mobile phone 501, rewards account server 403, etc.) can be configured to receive, retrieve, create, and/or present the redemption portal 600 shown in FIG. 6.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method comprising:
receiving, from a holder of a rewards account, a request for redemption information, wherein the rewards account is maintained by a financial institution;
determining, using a processor, that the rewards account is associated with an organization, wherein the organization is not the financial institution, and wherein the organization is associated with a brand; and
presenting a redemption portal to the holder, wherein the redemption portal presents one or more products, and wherein the redemption portal comprises a theme that conveys the brand.

2. The method of claim 1, wherein the theme comprises at least one of a background, wallpaper, window, scroll bar, or cursor that conveys the brand.

3. The method of claim 1, wherein each of the one or more presented products conveys the brand.

4. The method of claim 1, wherein the brand comprises at least one of a name, sign, symbol, trademark, slogan, or color combination associated with the organization.

5. The method of claim 1, wherein the organization comprises at least one of a charity, sports team, college, airline, or retailer.

6. The method of claim 1, wherein the determining that the rewards account is associated with the organization is based at least partially on a determination that one or more account materials associated with the rewards account convey the brand.

7. The method of claim 1, wherein the determining that the rewards account is associated with the organization is based at least partially on a determination that the holder selected the organization for association with the rewards account.

8. The method of claim 1, wherein the determining that the rewards account is associated with the organization is based at least partially on a determination that one or more rewards accumulated by the rewards account have been previously redeemed for one or more products conveying the brand.

9. The method of claim 1, further comprising:
receiving information indicating that the holder has selected the organization for association with the rewards account, wherein the receiving the information occurs before the receiving the request for redemption information; and
associating the organization with the rewards account based at least partially on the receiving the information.

10. The method of claim 9, further comprising:
presenting a user interface to the holder, wherein the user interface enables the holder to select the organization for association with the rewards account, and wherein the presenting the user interface occurs before the receiving the request for redemption information.

11. The method of claim 10, wherein the user interface presents a plurality of organizations from which the holder can select.

12. The method of claim 1, further comprising:
creating the redemption portal before the receiving the request for redemption information, and wherein the determining that the rewards account is associated with the organization occurs after the receiving the request for redemption information.

13. The method of claim 1, wherein the determining that the rewards account is associated with the organization occurs before the receiving the request for redemption information, the method further comprising:
creating the redemption portal before the receiving the request for redemption information, and wherein the creating the redemption portal is based at least partially on the determining that the rewards account is associated with the organization.

14. The method of claim 1, further comprising:
creating the redemption portal after the receiving the request for redemption information and based at least partially on the determining that the rewards account is associated with the organization.

15. The method of claim 1, further comprising:
receiving information indicating that the holder has selected a product from the one or more products, wherein the receiving the information occurs after the presenting the redemption portal to the holder; and
providing the product to the holder.

16. The method of claim 1, further comprising:
receiving, from a second holder of a second rewards account, a second request for redemption information, wherein the second rewards account is maintained by the financial institution;
determining, using a processor, that the second rewards account is associated with a second organization, wherein the second organization is not the financial institution, wherein the second organization is not the organization, and wherein the second organization is associated with a second brand; and
presenting a second redemption portal to the second holder, wherein the second redemption portal presents one or more second products for selection, and wherein the second redemption portal comprises a theme that conveys the second brand

17. The method of claim 16, wherein the organization comprises a charity, wherein the brand comprises the name of the charity, wherein the second organization comprises a sports team, and wherein the second brand comprises a logo associated with the sports team.

18. An apparatus comprising:
a communication interface configured to receive, from a holder of a rewards account, a request for redemption information, wherein the rewards account is maintained by a financial institution; and
a processor operatively connected to the communication interface and configured to:
determine that the rewards account is associated with an organization, wherein the organization is not the financial institution, and wherein the organization is associated with a brand; and
instruct the communication interface to present a redemption portal to the holder, wherein the redemption portal presents one or more products, and wherein the redemption portal comprises a theme that conveys the brand.

19. The apparatus of claim 18, wherein each of the one or more presented products conveys the brand.

20. The apparatus of claim 18, wherein the processor determines that the rewards account is associated with the organization by determining that the holder selected the organization for association with the rewards account.

21. The apparatus of claim 18, wherein the processor determines that the rewards account is associated with the organization by determining that one or more rewards accumulated by the rewards account have been previously redeemed for one or more products conveying the brand.

22. The apparatus of claim 18, wherein the communication interface is further configured to receive information indicating that the holder has selected the organization for association with the rewards account, wherein the communication interface receives the information before receiving the request for redemption information, and wherein the processor is configured to associate the organization with the rewards account based at least partially on the communication interface receiving the information.

23. The apparatus of claim 22, wherein the processor is further configured to instruct the communication interface to present a user interface to the holder, wherein the user interface enables the holder to select the organization for association with the rewards account, and wherein the processor instructs the communication interface to present the user interface to the holder before the communication interface receives the request for redemption information.

24. The apparatus of claim 18, wherein the processor is further configured to create the redemption portal.

25. The apparatus of claim 18, wherein the communication interface is configured to receive information indicating that the holder has selected a product from the one or more products, wherein the communication interface receives the information after presenting the redemption portal to the holder, and wherein the processor is configured to generate an order to provide the product to the holder based at least partially on the communication interface receiving the information.

26. A computer program product comprising a non-transitory computer-readable medium, wherein the non-transitory computer-readable medium comprises one or more computer-executable program code portions that, when executed by a computer, cause the computer to:
determine that a rewards account maintained by a financial institution is associated with an organization, wherein the organization is not the financial institution, and wherein the organization has a brand; and
present a redemption portal to a holder of the rewards account based at least partially on the computer determining that the rewards account is associated with the organization, wherein the redemption portal presents one or more products, and wherein the redemption portal is branded with the brand of the organization.

27. The computer program product of claim 26, wherein the one or more presented products conveys the brand.

28. The computer program product of claim 26, wherein the one or more computer-executable program code portions, when executed by the computer, cause the computer to:
access an account profile associated with the rewards account; and
determine that the rewards account is associated with the organization based at least partially on information stored in the account profile.

29. The computer program product of claim 26, wherein the one or more computer-executable program code portions, when executed by the computer, cause the computer to:
determine that the rewards account is associated with the organization based at least partially on the computer determining that one or more rewards accumulated by the rewards account have been previously redeemed for one or more products conveying the brand.

30. The computer program product of claim 26, wherein the one or more computer-executable program code portions, when executed by the computer, cause the computer to:
present a user interface to the holder, wherein the user interface enables the holder to select the organization for association with the rewards account, wherein the computer presents the user interface before receiving the request for redemption information;
receive information indicating that the holder has selected the organization for association with the rewards account; and
determine that the rewards account is associated with the organization based at least partially on the computer receiving the information.

31. The computer program product of claim 26, wherein the one or more computer-executable program code portions, when executed by the computer, cause the computer to:
create the redemption portal.

32. A method comprising:
receiving, from a holder of a rewards account, a request for redemption information, wherein the rewards account is maintained by a financial institution;
determining, using a processor, that the rewards account is associated with an organization, wherein the organization is not the financial institution, and wherein the organization is associated with a brand;
retrieving one or more products from a library of products, wherein each of the one or more retrieved products conveys the brand; and
presenting, to the holder, a redemption portal comprising the one or more retrieved products.

33. The method of claim 32, wherein the redemption portal comprises a theme that conveys the brand.

34. The method of claim 32, wherein the determining that the rewards account is associated with the organization is based at least partially on a determination that one or more account materials associated with the rewards account convey the brand.

35. The method of claim 32, wherein the determining that the rewards account is associated with the organization is based at least partially on a determination that the holder selected the organization for association with the rewards account.

36. The method of claim 32, wherein the determining that the rewards account is associated with the organization is based at least partially on a determination that one or more rewards accumulated by the rewards account have been previously redeemed for one or more products conveying the brand.

37. The method of claim 32, further comprising:
receiving information indicating that the holder has selected a product from the one or more presented products, wherein the receiving the information occurs after the presenting the redemption portal to the holder; and
providing the product to the holder.
